(19) United States
(12) Patent Application Publication
(10) Pub. No.: US 2005/0110748 A1
(43) Pub. Date: May 26, 2005

(54) Tomography-capable apparatus and operating method therefor

(76) Inventors: Dieter Boeing, Muhlhausen (DE); Lutz Gundel, Erlangen (DE); Helmut Kropfeld, Forchheim (DE); Heiko Mehldau, Nurnberg (DE); Dirk Roscher, Buttenheim (DE); Werner Schmidt, Forchheim (DE); Christoph Taegert-Kilger, Erlangen (DE); Johann Uebler, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 10/949,905

(22) Filed: Sep. 24, 2004

(30) Foreign Application Priority Data
Sep. 26, 2003 (DE) 103 45 073.4

(51) Int. Cl. G09G 5/00

(52) U.S. Cl. 345/156

(57) ABSTRACT

In a tomography-capable imaging examination apparatus, and an operating method therefor, an operator first determines a desired scan volume of the examination subject, and then, controlled by the computer device, a raw data set, having data allocated to different directions, is acquired in the scan volume. For planning the subsequent calculation of the resulting image—keeping pace with the scan or immediately after its termination—the computer device calculates and displays a graphic overview representation of the subject of examination from the raw data. The overview representation contains three-dimensional information about the scan volume. In this volume, the operator selects a diagnostically relevant region of representation. Using an image calculation algorithm, the computer device calculates a diagnostically relevant resulting image in the selected region of representation. The quantity of data thus is reduced immediately upon its origination. The evaluation of the data can be accelerated, and a prospective quality control can be carried out.

### BACKGROUND OF THE INVENTION

1. Field of the Invention

The present invention concerns imaging examination apparatuses and methods that are capable of tomography, with which penetrating radiation that penetrates an examination from the exterior or that originates in the subject can be acquired from various directions relative to a system axis.

2. Description of the Prior Art

Examination apparatuses of the above type use, for example, x-rays that are emitted by an x-ray source and that penetrate the subject. Such apparatuses also include x-ray computed tomography apparatuses, in particular having x-ray tubes that can be rotated continuously around the system axis, and also include known as C-arm x-ray apparatuses. Examination apparatuses in the sense of the present invention also include ultrasound tomography apparatuses in which ultrasound waves penetrating the subject of examination are detected, as well as tomography, capable imaging examination apparatuses in nuclear medicine, whereby the examination subject itself emits radiation. These include for example positron emission tomography apparatuses (PET) and SPECT (Single Photon Emission Computed Tomography) apparatuses. An examination apparatus in the sense of the present invention includes a measurement system that can be rotated around a system axis.

In the operation of such apparatuses, it is known for an operator to determine a desired scan volume of the examination subject, i.e., to enter such a volume as an input into the computer device, for example, and controlled by the computer device, to acquire a raw data set in the scan volume that contains data allocated to different directions.

Various methods or devices are known that enable an improved determination of a scan volume that is relevant for the diagnosis.

From German OS 100 01 492, a method is known for producing a tomogram that enables an improved determination of a scan volume that is relevant for the diagnosis by the calculation of two-dimensional projection images from a projection direction that can be freely selected. The raw data necessary to produce the tomogram are acquired by means of a CT exposure made at a low radiation dosage, that is independent of the actual diagnostic exposure.

From German Patent 41 03 588, a computed tomography apparatus is known in which a shadow image is produced simultaneously with the acquisition of raw data, in order to monitor an exposure volume.

Images obtained using modern imaging medical apparatuses, e.g. a multi-slice CT apparatus (MSCT=Multi-Slice CT), have a relatively high resolution in all directions, so that they can be used to produce 3-D exposures (volume data sets). Volume data sets contain a greater quantity of data then image data sets of conventional two-dimensional images, and for this reason an evaluation of volume data sets is relatively time-consuming. The actual acquisition of the volume data sets lasts only a few minutes, but the organization and preparation of the volume data set often requires half an hour or more. Volume data sets often represent not only an unsurveyable flood of data, but also lead to storage space problems in archiving or intermediate storing.

Until about the year 2000, in computed tomography (CT) virtually the only standard practice was to make a diagnosis based on axial slice stacks (tomogram) or at least to rely predominantly on transverse tomograms in order to make a diagnostic finding. These transverse tomograms represent the primary images (primary data), obtained from the projection values (raw data, sinugram) through image reconstruction. A standard type of visualization, which however does not represent an actual 3-D method, consisted and consists in a slideshow-type sampling of a slice stack, in which slices are displayed one alter the other.

Since about 1995, due to the increasing computing power of computers, 3-D representations at separate workstations have been known. For this purpose, based on the volume data set, a post-processing then takes place, generally with secondary images being produced. In order to help the physician make a diagnosis, essentially four basic methods of 3-D visualization are used:
1. Multiplanar Reformatting (MPR): This is understood as a recombination of the volume data set in an orientation different from that of, for example, the original vertical slice. In particular, a distinction is made between the orthogonal MPR (three MPRs, each perpendicular to a coordinate axis), the free MPR (oblique slices: derived=interpolated), and the curved MPR (production of slices parallel to an arbitrary path through the image of the body of the subject, and for example perpendicular to the MPR in which the path was drawn).
2. Shaded Surface Display (SSD): Segmentation of the volume data set and representation of the surface of the cutout objects, mostly strongly determined by being based on the CT values and manual auxiliary editing.
3. Maximum Intensity Projection (MIP): Representation of the highest intensity along each ray path. In so-called Thin MIP, only a partial volume is represented.
4. Volume Rendering (VRT): This is understood as a modeling of the attenuation of the visual ray, which penetrates the object in a manner comparable to an x-ray beam, In this way, the overall depth of the imaged body (partially translucent) is acquired; In some circumstances details of small objects, and above all those represented in thin slices, are lost. The representation is manually determined by the setting of transfer functions (color lookup tables).

### SUMMARY OF THE INVENTION

An object of the present invention is to provide a method and a tomography capable apparatus with which the further processing of the measurement data and/or the diagnosis based on the measurement data of the tomography-capable imaging examination apparatus can be carried out more rapidly and more easily by the physician or by an operator.

This object is achieved according to the invention by a method wherein for the purpose of planning the subsequent calculation of the resulting image—keeping pace with the scanning or immediately after the termination thereof—a computer device calculates a graphic overview representation of the examination subject from the raw date and displays the overview representation containing three-dimensional information about the scan volume, the operator selects a region for representation relevant to the diagnosis, using the overview representation, and by means of an image calculation algorithm, the computer device calculates in the selected representation region a diagnostically relevant resulting image, in particular a secondary image.

The present invention is based on the recognition that the flood of data in the production of tomograms, which today has become, to a certain extent, unsurveyable, can be dammed. For this purpose, the present invention is based on subject of examination, or the patient. Coronal Images (x-z) are images in a plane perpendicular to the sagittal plane and to the transverse plane. The coronal plane is also called the frontal plane.

The terms secondary slice, secondary tomogram, or secondary image designate a tomogram that has an orientation different from that of the slice plane, e,g. a sagittal image, a coronal image, or an oblique image. In a generalization of this meaning, in connection with the present invention the term “secondary image” generally designates a two-dimensional or three-dimensional image that is not a two-dimensional tomogram. Accordingly, a secondary image can be a to-dimensional image (e.g. by means of MPR) having an orientation different than that of the slice plane, or can be an arbitrarily oriented three-dimensional image (e.g. by means of VRT, MIP, SSD, etc.).

The resulting image, In the sense of the present invention, can be a secondary image, but the resulting image need not necessarily be, an image calculated immediately from raw data.

In the sense of the present invention, a computer device can be formed by one or more computers, e.g. personal computers or workstations. The computer device is allocated to the imaging examination apparatus, in particular spatially and/or organizationally, and/or by data and/or control lines. Preferably, the computer device and the imaging examination apparatus form a unified or common workplace, in particular in such a way that the computer device carries out both the measurement operation of the imaging examination apparatus as well as the calculation of the resulting image, in particular of the secondary image.

Before the operator enters the desired scan volume, a topogram can be obtained. Alternatively, a light-beam localizer can be used to determine the starting and ending position of the examination.

In a preferred embodiment, the raw data set is acquired in such a way that a volume data set can be produced there from that is isotropic, or is quasi- (nearly) isotropic. Thus, for example raw data are acquired in such a way that an isotropic or quasi-isotropic volume scanning is ensured as a basis for the production of a volume data set. An isotropic or quasi-isotropic data set allows an especially large range of selections to be offered during the selection of the diagnostically relevant region of representation on the basis of the overview representation, e,g., a selection of secondary slices having arbitrary orientation, or zoom options.

According to another preferred embodiment, the calculation and/or display of the graphic overview representation of the examination subject is carried out automatically by the computer device and/or interactively with the operator, the latter taking place in particular in real time and/or adapted to a specific diagnostic problem at hand. In both cases (automatic or interactive), it is advantageous for the CT apparatus to operate, or to be set by the user to operate, so that the three-dimensional overview representation is offered as a general planning mode immediately during the scanning or immediately after the termination thereof, without displaying any axial tomograms (primary data). This significantly improves the user-friendliness, because the user is not overburdened with an unnecessary flood of data.

The calculation of the overview representation is in particular carried out by means of an image reconstruction algorithm.

Furthermore, it is preferable for the image reconstruction algorithm to be preset at the computer device, in particular with respect to the reconstruction parameters, whereby, for different selectable scan protocols different types of image reconstruction algorithms or differently parameterized image reconstruction algorithms are stored. In this way, the overview representation can be obtained without requiring decisive user input, or any user input at all related thereto. Such an automatic or quasi-automatic reconstruction is important particularly in connection with the production of an isotropic volume data set, preferably a data set having the highest possible resolution. Scan protocols can be present for example for the thorax, head, abdomen. etc. Reconstruction parameters can include slice thickness, sharpness (resolution), type of convolution kernel, or the like.

In the following, two preferred versions of the display in the planning mode are described:

According to a first version, the overview representation includes three views, which are not parallel to each other and are in particular orthogonal to one another, of the subject. Such a representation makes it easy for the user to plan the desired resulting image, in particular from secondary images or high-precision axial slices. The user can verify whether the planned resulting image or images cover the desired region.

Preferably, the orthogonal views are a transverse image, a sagittal image, and a coronal image. It is advantageous for the orthogonally situated views to be produced by multiplanar reformatting (MPR) or by maximum intensity projection (MIP).

According to the second version, the overview representation includes at least one three-dimensional image of the subject of examination, i.e., at least a three-dimensional visualization, produced in particular using Volume Rendering (VRT). By adapting a wide parameter space, this variant offers a very large degree of variance in the representation (appearance) of an acquired volume data set. Different image types are possible.

With respect to the cited versions and possible further variants for the determination of the overview representation, it is particularly advantageous for the computer device to have or allow presets for the type of overview representation. For example different types of overview representations for different selectable scan protocols, or differently parameterized overview representations, are stored or can be stored. In this way, it is possible to immediately offer the user, via “default settings,” highly realistic and accurate representations. For example, for “thorax” an MPR representation could be used, and for “angio” an MIP representation could be used. The overview representation can also be configurable and/or preadjustable in a user-specific, i.e, individual, fashion.

In the planning mode, the selection of the diagnostically-relevant region of representation preferably takes place by means of a display screen pointer that can be navigated in the overview representation, controlled for example by a computer mouse or by a joystick.

For the selection of the diagnostically relevant representation region, preferably the size, the position, and/or the orientation of the resulting image, in particular of a secondary tomogram are entered into the computer device. The user is thus able to navigate the overview representation after the scan, or the overview representation can grow during the scan, in the desired plane.

According to a further preferred embodiment, the computer device calculates the diagnostically relevant resulting image in a well-directed fashion in the selected region of representation, with the resulting image being calculated in such a way that not all the transverse tomograms that can theoretically be calculated from the raw data set are completely calculated. This makes a particulary high degree of date reduction possible, and thus also accelerates of the production of the medlioally relevant images.

Preferably, the computer device calculates the resulting image without calculating transverse (axial) tomograms at all, or at least without calculating axial thin-slice tomograms. In particular, a direct reconstruction of non-axial tomograms, or of secondary images In general, can be carried out.

Preferably, before the calculation of the resulting image, the operator can enter at least one of the target parameters image sharpness, image spacing, slice thickness, and/or image segment into the computer device. The entered target parameters can be used by the computer device to optimize the calculation of the resulting image.

Further preferred embodiment of the method according to the present invention relate to the calculation of the resulting image or images.

If the image reconstruction has taken place with sufficient precision for the determination of the overview representation, a new image reconstruction for the calculation of the resulting image can be omitted in certain circumstances, depending on the diagnostic problem at hand. In particular, reference is made here to the second version cited below.

For the calculation of the resulting image, the following versions are preferably used:

According to a first version, the calculation of the resulting image or images is carried out based on the raw data set recorded in the scan volume.

It is possible for the computer device to carry out an image reconstruction, in particular a new one, for the calculation of the resulting image.

The image reconstruction algorithm that is first carried out, and is in particular preset, is preferably operated with a lower degree of precision and/or a shorter computing time than the new image reconstruction algorithm for the subsequent calculation of the resulting image. A high-quality reconstruction is therefore no longer a precondition for the planning mode, so that this mode is advantageously available a very short time after the scan, for example only a few seconds at the latest.

The new image reconstruction takes place in particular using the Adaptive Multiple Plane Reconstruction (AMPR) method, as described in the article by S. Schaller, K. Stierstorfer, H. Bruder, et al., “Novel approximate approach for high-quality image reconstruction in helical cone beam CT at arbitrary pitch,” Proceedings SPIE 4322 (2001) 113-127.

Before the new image reconstruction, the user can optionally determine the target parameters, such as for example the type of reconstruction method, convolution core, image sharpness, image spacing, slice thickness, and/or image segment.

It is also possible for the computer device to automatically determine the image reconstruction algorithm for the reconstruction of the resulting image with respect to its type and/or its reconstruction parameters, after the operator has selected a diagnostically relevant region of representation in the overview representation. Preferably the optionally entered target parameters for the resulting image are taken into account by the computer device in the determination of the image reconstruction algorithm.

According to a second version, the calculation of the resulting image or images takes place on the basis of the overview representation, i.e., on the basis of the data underlying (in particular, immediately underlying) this representation. Preferably, a new image reconstruction is not carried out

For this purpose, the computer device preferably carries out a retrospective filtering for the calculation of the resulting image. In general, here the method according to German published application DE 102 383 22 A1 (corresponding to U.S. Patent Application Pub. No. 2004/0066912 A1) can be used, the disclosure of which is incorporated herein by reference.

The following methods [1] and/or [2] can be used, with [2] being particularly advantageous.

[1]. Method for the window-controlled filtering of CT images, including:
a) recording a CT raw data set using a CT apparatus or a C-arm apparatus,
b) reconstructing of a primary data set from the CT raw data set by means of a convolution kernel, for example a sharp kernel, and a slice sensitivity profile that is for example narrow,
c) providing a transfer function as a functional connection between the window width and the image sharpness,
d) automatically calculating the image sharpness of the CT image of a selected slice located in the primary data set, dependent on a selected window width for the selected slice, using an image processing process on the basis of the transfer function.

[2]. Method for the retrospective filtering of CT images, including:
a) recording a CT raw data set using a CT apparatus or using a C-bend apparatus,
b) reconstructing a primary data set on the basis of a (for example sharp) convolution kernel and a (for example narrow) slice sensitivity profile,
c) reconstructing of an image stack with a corresponding image characteristic on the basis of the primary data set,
d) calculating a modified image characteristic of the image stack through an image processing process running in the background on the image computer,
e) displaying a visualization of the image stack in the form of CT images having the modified image characteristic.

Thus, an adaptation of image sharpness, image spacing, slice thickness (slice spacing), and/or image segment, orientation, and position can be carried out online without a new reconstruction.

According to another preferred embodiment, after the obtaining of the resulting image or the obtaining of all optionally additionally reconstructed resulting images, the resulting image or images are stored in the computer device or are transmitted to a separate computer device. In this way, there results the possibility of getting along with significantly less storage and/or transmission capacity than is the case in the known procedures.

In particular, the storing or transmission can take place without the storing or transmission of a stack of transverse tomograms, in particular thin-slice images, or at least without the storing or transmission of the complete originally acquired slice stack.

Moreover, it is particularly advantageous if steps a) to e) are, supported by a common computer program, whereby steps a) to e) are preferably carried out by the operator with an overarching user interface.

The present invention also relates to an x-ray computed tomography apparatus operable for execution of the method according to the present invention.

### DESCRIPTION OF THE DRAWINGS

FIG. 1 shows, in a partly perspective, partly schematic view, an examination apparatus, fashioned as a CT apparatus, for the execution of the method according to the present invention.

FIG. 2 shows a known procedure for producing a medically useful image of a patient by means of a CT apparatus, in a highly schematized representation.

FIG. 3 shows an embodiment of procedure according to the present invention for producing a medically useful image of a patient by means of a CT apparatus, in a highly schematized representation.

FIG. 4 is a flowchart of a first exemplary embodiment of the method according to the present invention.

FIG. 5 shows an example of an overview representation obtained in accordance with the present invention.

FIG. 6 is a flowchart of a second exemplary embodiment of the method according to the present invention.

FIG. 7 is a flowchart of a known method.

FIG. 8 is a flowchart of a third exemplary embodiment of the method according to the present invention.

### DESCRIPTION OF THE PREFERRED EMBODIMENTS

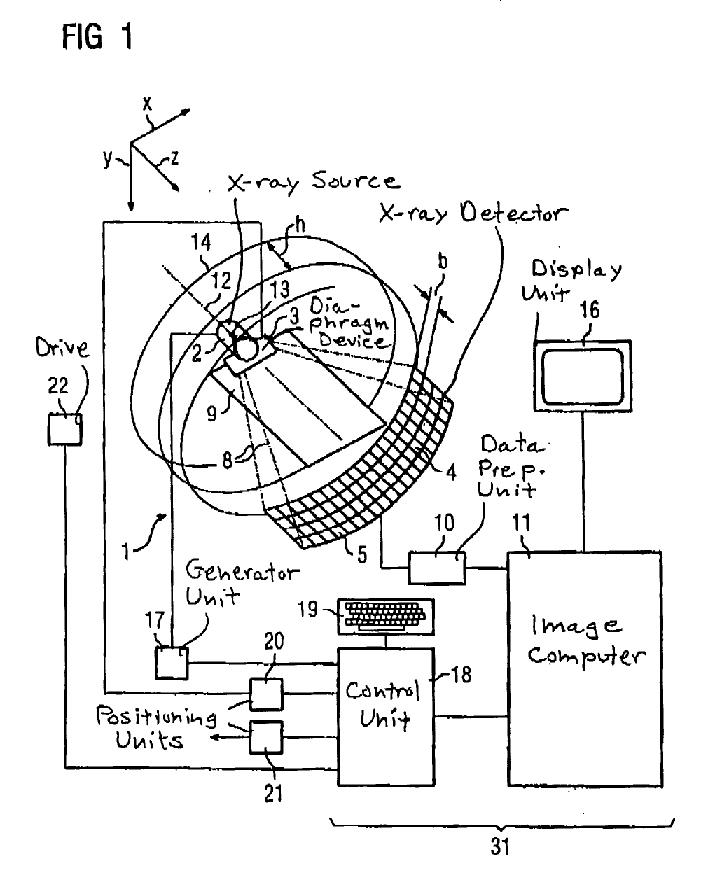

FIG. 1 shows the basic components of a third-generation CT apparatus for implementing the inventive method 1. Its measurement system includes an x-ray source 2 with a diaphragm device 3 positioned in front of it, close to the source, and an x-ray detector 5, constructed as a multi-row or surface-wide array of a plurality of rows and columns of detector elements (one of these is designated 4 in FIG. 1), having a diaphragm (not shown explicitly) close to the detector 5, situated in front of it, For clarity, in FIG. 1 only four rows of detector elements 4 are shown, but x-ray detector 5 can have additional rows (e.g., a total of 16) of detector elements 4, and these may also have differing widths b. The x-ray detector 5 can be fashioned as a solid-state matrix detector system, in particular as a flat panel image, detector and/or as a detector having a scintillator layer as well as an allocated electronic photodetector matrix. These detectors have the advantage that they can also be manufactured in flat fashion, as 2D image detectors, at a low manufacturing expense.

The x-ray source 2 with the diaphragm device 3 the x-ray detector 5 with its diaphragm are attached to a rotating frame (gantry; not explicitly shown) opposite one another in such a way that a pyramid-shaped bundle of x-rays that emanates from the x-ray source 2 during operation of the CT apparatus 1 is grated by the adjustable diaphragm device 3 (edge beams there of being designated 8), strikes the x-ray detector 5.

The rotating frame can be set into rotation around a system axis 12 by a drive device (not shown). The system axis 12 runs parallel to the z-axis of a Cartesian coordinate system shown in FIG. 1.

The columns of the x-ray detector 5 likewise run in the direction of the z-axis, while the rows, whose width b is measured in the direction of the z-axis and is for example 1 mm, run transverse to system axis 12, or to the z-axis.

In order to bring the examination subject, e.g. the patient, into the path of the x-ray beam bundle, a positioning device 9 is provided that can be moved parallel to the system axis 12, i.e., in the direction of the z-axis, with a synchronization between the rotational movement of the rotating frame and the translational movement of positioning device 9, so that the ratio of translational movement to rotational movement is constant. This ratio can be set by selecting a desired value for the advance h of the positioning device 9 per rotation of the rotating frame.

Thus, a volume of a subject of examination situated on positioning device 9 can be examined in the course of a volume scan. The volume scan is cared out in the form of a spiral scan, in the sense that a multiplicity of projections from various projection directions are obtained per rotation of the rotating frame, with simultaneous translation of positioning device 9. During the spiral scan, the focus 13 of x-ray source 2 moves on a spiral path 14 relative to positioning device 9. Alternatively to this spiral scan, a sequence scan is also possible.

The measurement data that are read out in parallel from the detector elements 4 of each active row of the detector 5, and that correspond to the individual projections, are subjected to digital/analog conversion in a data preparation unit 10, are serialized, and are transmitted as raw data to an image computer 11 that displays the result of an image reconstruction on a display unit 16, e.g. a video monitor.

The x-ray source 2, for example an x-ray tube, is provided with the required voltage and current by a generator unit 17, which optionally also rotate together with the frame. In order to enable this generator unit to be set to the required values, the generator unit 17 is provided with a control unit 18 having a keyboard 19, permitting the necessary settings.

The other aspects of the operation and controlling of CT apparatus 1 take place by means of the control unit 18 and the keyboard 19, which is illustrated by the control unit 18 being shown as connected to image computer 11.

Among other features, the number of active rows of detector elements 4, and therewith the position of the diaphragm device 3 and the optional-diaphragm close to the detector, can be set, for which purpose the control unit 18 is connected to the diaphragm device 3 and to positioning units 20 or 21, which are allocated to the optional diaphragm close to the detector 5. In addition, the rotation time that the rotating frame requires for a complete rotation can be set, which is illustrated by a drive unit 22 allocated to the rotating frame being shown connected to the control unit 18.

Together with image computer 11, control unit 18 forms a computer device 31 that represents an integrated workstation that can be controlled and operated with complete functionality by a single operator. In particular it is operable according to the inventive method.

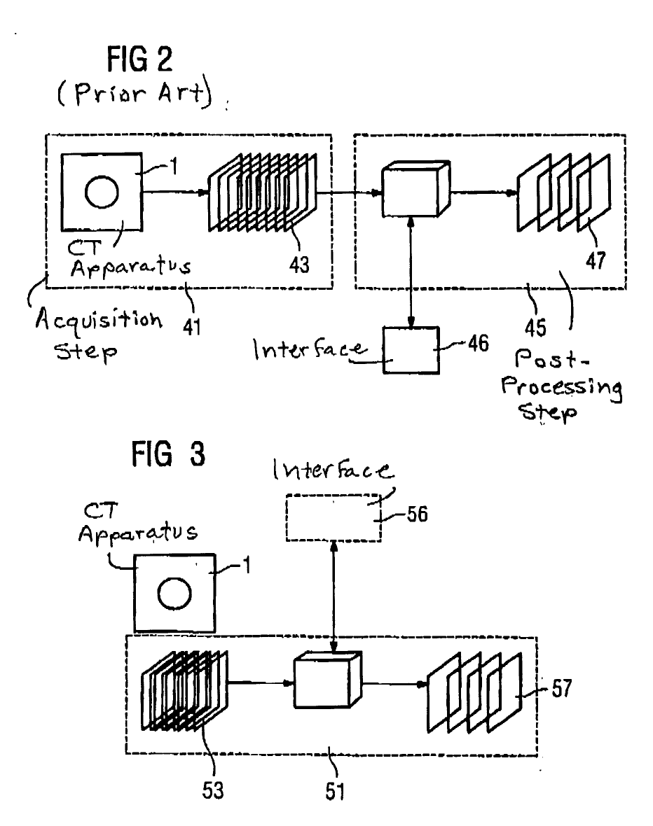

FIG. 2 shows a highly schematized representation of a known standard workflow for producing a medically useful image of a patient by means of the CT apparatus 1. In an acquisition step 41, a multiplicity of axial tomograms 43 are produced as a primary data set by the CT apparatus 1 and its image computer 11. Particularly in the case of thin-slice reconstruction, for example approximately 1000 axial images of this type are generated, With a time consumption of approximately 1-2 seconds per image, this can take up to 15 to 30 minutes. This extensive quantity of data presents problems in the evaluation and further processing of the data. The data produced at CT apparatus 1 must be transferred, in a separate post-processing step 45, to a connected separate workstation, and must be further processed there (to produce an extracted data set). At least a portion of the image data must even be transmitted first to the archive (PACS), in order to be made available from their to the workstations. At the workstation or workstations, particular medical applications or evaluations are then carried out using special software and with the interaction of the user via an interface 46. The person carrying out the post-processing must thereby begin with the multiplicity of axial tomograms 43. This can be considered as “slice diagnosis” or “slice evaluation”. If the operator does not have access to, for example, a 3-D viewer, the operator can proceed according to the above-mentioned slideshow-type sampling of the slice stack in order to determine or to define diagnostically useful images. The result of the post-processing 45 is one, or a few, diagnostically relevant images 47. If, during the post-processing 45, it should turn out that the primary data set or even the raw data set are unsuitable for the desired diagnostic problem at hand, the CT apparatus 1 must run through the entire procedure again. With image reconstruction and data transmission, or even with a new scan. Finally, already during the planning of the primary data (axial tomograms), the user must more or less know which parameters are required in order to obtain qualitatively high-value secondary images, e.g. non-axial slices, In FIG. 3, in the same way a procedure according to the present invention is presented for comparison to FIG. 2. First, a large number of tomograms 53 are likewise produced by CT apparatus 1. In the interaction with the operator via interface 56, however, only a compact and easily surveyable three-dimensional representation is displayed, using volume rendering (VRT). In this way, the operator obtains a real-time visualization, and can immediately select the diagnostically relevant data set. In this way, the quantity of data can be reduced directly at the location of its origin to the few images 57 that are actually diagnostically relevant. This can be considered as “volume diagnosis.” The production of the diagnostically relevant images 57 is thus an integral part of the data recording. The data acquisition and the production of the diagnostically relevant images take place in a common step 51 and with the use of a common software user interface; in particular, this takes place on the common computer device 31 or common image computer 11.

Furthermore, the procedure according to the present invention results in the possibility of visual real-time quality-control, because it can be recognized immediately if the primary data set or even the raw data set is not suitable for the diagnostic problem at hand with sufficient quality.

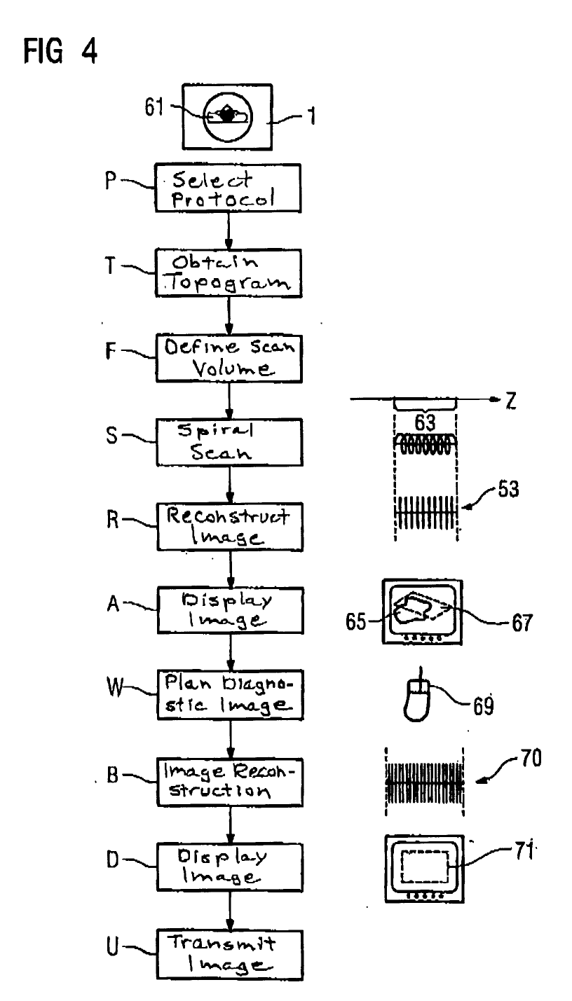

FIG. 4 shows a first exemplary embodiment of the method according to the present invention, in detail.

The user (operator, physician, radiologist, MTA, etc.) first selects a predefined examination protocol from a database (Symbol P). After the examination subject 61 (patient) has been brought into the opening of the computer tomography apparatus 1, the user obtains a topogram T. The examination region or scan volume 63 is then defined by corresponding inputs (Symbol F). Subsequently, a spiral scan S is carried out in the desired scan volume 63. Here, raw data are recorded in such a way that an isotropic or quasi-isotropic volume data set can be produced therefrom. The voxels of the volume data set are approximately cube-shaped.

The following steps for the reconstruction of an image R and its displaying A take place in a manner controlled automatically by computer device 31 and in real time with spiral scan S:

Dependent on the selected examination protocol, the image reconstruction R is carried out using a method and/or parameters (standard kernel, etc.) that ensure a rapid processing of data, without having already to fulfill the requirements of the finally desired resulting image 71. The resulting stack of tomograms 53 fulfills the requirements for the following planning mode (A, W) on the basis of the overview representation 65, without the reconstruction being carried out with parameters that ensure a high image quality. For example, these tomograms 53 need not necessarily be thin-slice images. The data obtained from the measurement are displayed in a “real-time-volume-growing-mode,” e,g., MPR, MIP, or VRT, and in the case of VRT this preferably takes place in interaction with the user. In this way, the planning of high-resolution axial slices or of secondary images is possible already only a few seconds after the end of the scan.

The following step W, required for the planning, in the selection of a diagnostically relevant region 67 of representation can also be carried out already during the measurement, at least at the beginning, in that the user navigates the 3-D object growing on the monitor into the desired plane of representation. The selection W of the diagnostically relevant region 67 of representation, in particular with respect to size, position, and/or orientation of the resulting image 71, is carried out by the user by means of a position-sensitive input unit 69 that produces a display screen pointer that can be navigated. It is important that this viewing component be an integral component of the operating software of computer tomography apparatus 1, so that the volume data set, available immediately after the scan, can serve as a basis for the definition of a series of thin slices. A display axial tomograms of the produced stack 53 is not carried out by computer device 31 as long as the user does not expressly request such a display.

After the diagnostically relevant region 67 of representation has been defined, the computer device 31 carries out a high-quality image reconstruction B, using the parameters determined during the selection W, such as for example resolution, slice thickness, etc., insofar as this image reconstruction is required as an input for the desired diagnostic problem at hand or application. This image reconstruction B now need no longer extend to the entire volume, i.e., it is no longer necessary for all the transverse tomograms that can in theory be calculated from the raw data set obtained during the scan S actually to be calculated, and in some circumstances many tomograms need not be calculated completely, However, if tomograms 70 are calculated, whether in whole or in part, this calculation takes place with high resolution as thin-slice images. From these tomograms 70, the resulting image 71 is then calculated and displayed on the monitor D.

It is also possible that, differing from what is shown, these tomograms 70 are not reconstructed as axial slices, but rather directly as oblique, tomograms (secondary tomograms), corresponding for example to the inclination that was determined with the diagnostically relevant region 67 of representation in the planning mode A/W.

In these ways, the volume of data is reduced at the location of origin, i.e., at the modality. Applications that up to now were available only in the context of a post-processing (MPR, MIP, VRT, SSD) are directly available for diagnosis, archiving, and documentation.

In the subsequent transmission U of the resulting image 71 into an archive (PACS), a comparatively low transmission capacity is required, and in the archive only a comparatively small amount of storage space is required, because only the data of the diagnostically relevant region 67 of representation are stored, or must be transmitted, and not an entire series of thin slices.

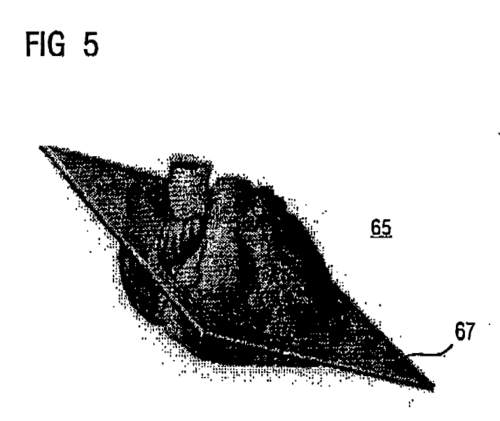

FIG. 5 shows an example of an overview representation 65 in the VRT mode, whereby the diagnostically relevant region 67 of representation is already selected as an oblique tomogram. In this representation, zoom functions are also available to the user.

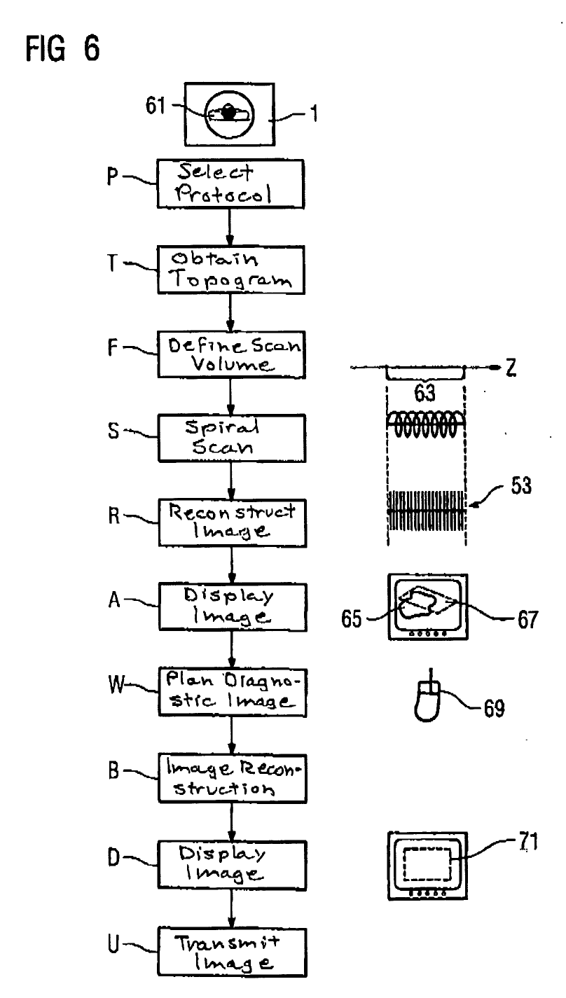

FIG. 6 shows a second exemplary embodiment of the method according to the present invention in detail, which is essentially identical with the exemplary embodiment of FIG. 4, insofar as nothing to the contrary is mentioned below.

In the second exemplary embodiment, an image reconstruction R is already carried out with a high degree of quality for the overview representation 65. This can be the case for example for particular examination protocols, of computed tomography apparatus 1.

The calculation of the resulting image or images 71 takes place, on the basis of the overview representation 65, i.e., the slice stack 53 that forms the basis of overview representation 65, without carrying out a new image reconstruction.

As far as is required, and in particular if a modification of the image parameters (noise, sharpness, etc,) is necessary, for the calculation of the resulting image 71 the computer device carries out a retrospective filtering using one of the methods according to the aforementioned published German application DE 102 383 22 A1. The filtering takes place in real time both in the axial direction and in the z direction. The set parameters, such as for example slice thickness, filter, etc., are always visualized. The user can set the image appearance an an approximate fashion from a gallery. Each adjustable filter can be selected using a thumbnail image. The filtering is also to be regarded as an integral component of the data acquisition, through which there results, due to the “internal” (post-) processing of the data, the possibility of subsequently accessing the complete acquired data set. This can be used for an improved image quality by application-specific optimization of the initial input data.

The computed tomography apparatus 1 can be configured, with its computer device 31, in such a way that the computer device 31 decides automatically, dependent on the parameters inputted by the user, such as for example image sharpness, slice thickness, image segment, etc., which type of image calculation 8 is carried out for the resulting image 71, with or without new reconstruction.

In the method according to the present invention, the qualitative evaluation of the resulting images can be prospectively carried out immediately after the examination, without having to start a high-quality reconstruction process for this purpose. In known methods, the evaluation can take place only retrospectively, after the reconstruction of all image series has been terminated; as a rule, this is only after many minutes. If the image quality is not sufficient a new reconstruction must be prepared and ordered.

In the method according to the present invention, a considerable data reduction is achieved by the direct production of diagnostically relevant image series. Thin-slice series as a basis for standard post-processing can be omitted. This makes possible a more rapid diagnosis. The compressed online overview presentation of the examined part of the anatomy enables an anatomically oriented selection of tomograms of diagnostically relevant organs. Clinically relevant image parameters can be adapted directly and immediately. An optimal quality-control is made possible through the prospective selection of the clinically relevant resulting images, online parameterization, and visualization. The comparative consideration of, for example, different image impressions through the variation of different reconstruction kernels is easier than was previously possible. In contrast to a separate post-processing, in which only the generated axial image stack is available, the integrated calculation of non-axial images offers the advantage that it is possible, through immediate access to the acquired data, in particular the raw data, to optimally adapt the image calculation in a prospective fashion, and thus to produce an improved image quality.

The resulting Image 71 can be a secondary tomogram, or a primary tomogram, or in general can be a reconstructed partial volume of an arbitrary image type.

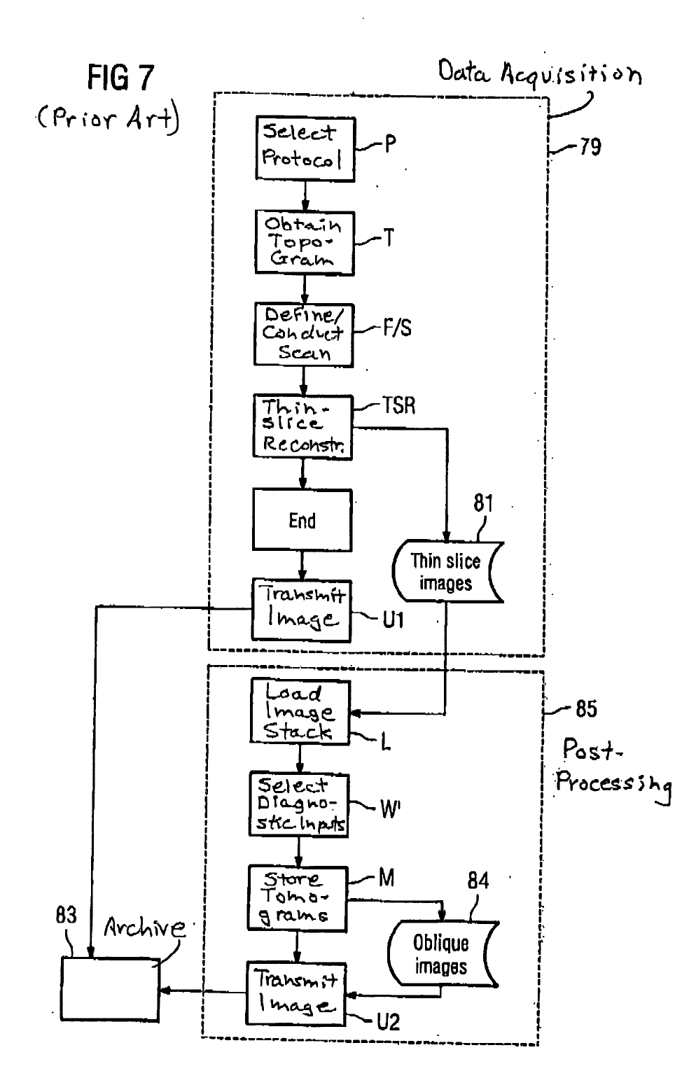

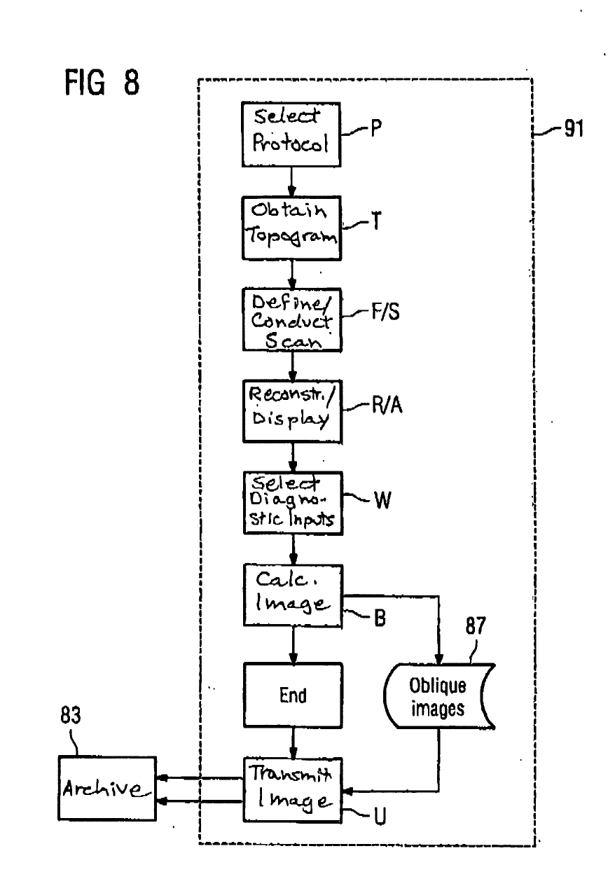

FIG. 7 shows a flowchart of a known method, and, in comparison thereto, FIG. 8 shows a third exemplary embodiment of the method according to the present invention. Identical symbols refer to exemplary embodiments already described above.

In the known procedure, the following steps are carried out:
A) Data acquisition 79:
   1. Loading of a predefined protocol (P),
   2. Optional scanning of a topogram (T),
   3. Determination of the scan region (F) and execution of the spiral or sequence scan (S),
   4. Setting, planning, and execution of a thin-slice reconstruction (TSR) with the result of a stack 81 of axial thin-slice images,
   5. End of the examination,
   6. Optional transmission (U1) of the topogram as a reference image to an archive 83; and then, after the transferring of a large quantity of data (extracted data set; cf. description of FIG. 2) to a separate console with a 3-D application:
B) Post-processing 85:
   1. Loading (L) of the stack 81 of axial thin-slice images into the 3-D application, in particular on a separate computer,
   2. Selection (W′) of the diagnostically relevant region of representation, the specific definition of the volume and of the parameters of the oblique tomogram 84, and calculation of the same, e.g. by means of an MPR or MIP method,
   3. Storing (M) of the oblique tomograms 84,
   4. Transmission (Ü2) of oblique tomograms 84 to archive 83.

A disadvantage of this procedure is that the user must know precisely, already during the planning of the axial tomograms, which parameters are required in order to obtain qualitatively high-value secondary slices, i.e., for example oblique tomograms.

In the third exemplary embodiment of the method according to the present invention according to FIG. 8, in comparison thereto, the following steps are carried out, whereby the data acquisition and the post-processing are integrated with one another, at the level of software, into a common user interface 91. This represents the standard workflow implemented at CT apparatus 1:
1. Loading of a predefined protocol (P),
2. Optional scanning of a scanogram or topogram (T),
3. Determination of the scan region of Interest (F) and execution of the scan (S),
4. From the raw data obtained in 3., reconstruction (R) and storing of images in diagnostic quality in real time, i.e., parallel to the emission of radiation. After the calculation of the images in diagnostic quality, the software automatically calculates (R) the planning volume, and automatically switches into a 3-D planning mode, in which an overview representation is displayed (A). The overview representation comprises, in three image segments, views standing orthogonal to one another of the volume to be reconstructed, which are calculated using parametrizable MPR or MIP methods. One of the segments represents a slice that is coaxial to the direction of reconstruction, and the other two represent orthogonal views, designated “side views” in the following. Each segment indicates the perimeter of the region to be reconstructed as a rectangle, as well as the positions of the two other slices.

The planning of non-axial slices is possible a few seconds after the termination of the scan (S), without requiring a high-quality reconstruction as a precondition therefor.
5. Selection (W) of the diagnostically relevant region of representation, specifically of tomograms that are oblique (inclined in relation to the z axis) and are oriented arbitrarily in space: through graphic interaction, in the overview representation, the size, position, and orientation of the region to be reconstructed can be modified. By moving the slice axes, others slices can be displayed. The contents of the respective other two segments are updated in real time.

Optionally, in a separate additional segment the user can obtain a preview of the planned image stack. Through the combination of side views and the preview, it is particularly simple for the user to verify whether the planned images cover the desired region.

The user determines the target parameters of the images to be reconstructed, i.e., the reconstruction method, image spacing, and slice thickness, and sends these to the image reconstruction module of the software.
6. Calculation (B) of the resulting image or of a stack of resulting images directly, in the form of oblique tomograms: the image reconstruction module directly calculates the tomograms of the selected region, using methods optimized to the target parameters, and using reconstruction parameters. Losses of image quality due to slice thicknesses that have been selected too large, or due to resolution of the axial images that is too low, as well as time losses due to slice thicknesses selected to be unnecessarily small, resulting in unnecessarily many axial images, can be avoided in this way.

An organ-adapted image reconstruction can also be used. The steps TSR and L according to FIG. 7 can be omitted. Thus, the operational sequence (workflow) does not begin with the planning of a high-resolution axial series of thin slices: rather, first the diagnostically relevant region is planned and a determined, and then the resulting image is calculated.

The resulting image can be displayed on a monitor.
7. End of the examination, e.g. through a corresponding user input,
8. After the termination of the planning, the system stores one of the two side views as a reference image. In this image, the position of the reconstructed images can be recognized through the representation of the corresponding slices. By storing the reference images the system ensures that the resulting images can be allocated according to their position in space. This method can be executed analogously to the storing of slice rows on a topogram.

Depending on the system configuration, the user can then automatically perform a transmission (U) of the resulting images together with the reference image to an archive 83, e.g. HIS/RIS system, and/or to a film system.

The images inclined in space are handled in the workflow in the same manner as axial images. That is, a special handling in the clinical workflow of further processing, calculation, and filming is no longer necessary.

Although modifications and changes may be suggested by those skilled in the art, it is the intention of the inventors to embody within the patent warranted hereon all changes and modifications as reasonably and properly come within the scope of their contribution to the art.

1. A method for operating a tomography-capable imaging apparatus, having a scanner that interacts with an examination subject to detect penetrating radiation emitted into, or originating within, the examination subject from multiple directions relative to a system axis, comprising the steps of:
manually entering a selected scan volume of said examination subject into a computer;
operating said scanner with said computer to obtain a raw data set of said scan volume with data in said raw data set being respectively allocated to different ones of said directions;
at a time no later than immediately following termination of obtaining said raw data set, electronically calculating in said computer a graphic overview representation of that said examination subject and displaying said graphic overview for allowing planning of a subsequent calculation of a diagnostic image, said graphic overview representation containing three-dimensional information about said scan volume;
based on the displayed overview representation, making a manual selection of a diagnostically relevant region in said graphic overview representation; and
calculating, in said computer using an imaging calculation algorithm, a diagnostically relevant image in said selected diagnostically relevant region of said graphic overview representation.

2. A method as claimed in claim 1 comprising beginning calculation in said computer of said graphic overview representation while said raw data set is being obtained.

3. A method as claimed in claim 1 comprising obtaining said raw data set in a form allowing a volume data set selected from the group of an istropic volume data set and a quasi-isotropic volume data set to be produced therefrom.

4. A method as claimed in claim 1 comprising calculating and displaying said graphic overview at representation automatically in said computer.

5. A method as claimed in claim 1 comprising calculating and displaying said graphic overview at representation in said computer based on manual interaction with an operator.

6. A method as claimed in claim 1 comprising employing an image reconstruction algorithm for calculating said graphic overview representation in said computer.

7. A method as claimed in claim 6 comprising storing a plurality of image reconstruction algorithms in said computer selected from the group consisting of different types of image reconstruction algorithms and at differently parameterized image reconstruction algorithms, and selecting one of these stored image reconstruction algorithm for use as said image reconstruction algorithm for calculating said graphic overview representation.

8. A method as claimed in claim 1 comprising calculating said graphic overview representation as three non-parallel views of said examination subject.

9. A method as claimed in claim 8 comprising calculating said graphics overview representation as three orthogonal views of said examination subject.

10. A method as claimed in claim 9 comprising calculating said graphics overview representation as a transverse image, a sagittal image and a coronal image of said examination subject.

11. A method as claimed in claim 9 comprising calculating said orthogonal views of said examination subject by a technique selected from the group consisting of multiplanar reformatting and maximum intensity projection.

12. A method as claimed in claim 1 comprising calculating said graphics overview representation to include at least one three-dimensional image of said examination subject.

13. A method as claimed in claim 12 comprising producing three-dimensional image by volume rendering.

14. A method as claimed in claim 1 comprising displaying said graphics overview representation on a display screen, and a selecting said diagnostically relevant region of said graphics overview representation by navigating a display screen pointer within said graphics overview representation on said display screen.

15. A method as claimed in claim 1 comprising selecting said diagnostically relevant region of said graphics overview representation by entering at least one of a size, position and orientation of that said diagnostically relevant image into said computer.

16. A method as claimed in claim 1 wherein said raw data set contains data allowing a theoretical number of transfer tomograms to be calculated therefrom, and wherein said computer device calculates diagnostically relevant image without calculating all of said transfer tomograms.

17. A method as claimed in claim 16 wherein said computer calculates said diagnostically relevant image without calculating any of said transfer tomograms.

18. A method as claimed in claim 1 comprising, before calculating said diagnostically relevant image in said computer, making an input into said computer selected from the group consisting of target parameters, image sharpness, image spacing, slice thickness and slice segment.

19. A method as claimed in claim 18 comprising entering target parameters into said computer that optimize calculation of said diagnostically relevant image.

20. A method as claimed in claim 1 comprising calculating said diagnostically relevant image from said raw data set of said scan volume.

21. A method as claimed in claim 1 comprising calculating said diagnostically relevant image using an image reconstruction method based on a different set of data from said raw data set of said scan volume.

22. A method as claimed in claim 21 comprising calculating said diagnostically relevant image as a direct reconstruction of non-axial tomograms.

23. A method as claimed in claim 21 comprising employing an image reconstruction algorithm for calculating said graphics overview image having at least one of a lower precision and a shorter computer time than the image reconstruction algorithm used for calculating said diagnostically relevant image.

24. A method as claimed in claim 23 comprising automatically determining in said computer the image reconstruction algorithm to be employed for reconstructing said diagnostically relevant image dependent on a type of said image reconstruction algorithm and reconstruction parameters of said image reconstruction algorithm, after selection of diagnostically relevant region from said graphics overview representation.

25. A method as claimed in claim 24 comprising automatically determining said image reconstruction algorithm in said computer additionally dependent upon target parameters for said diagnostically relevant image manually entered into said computer.

26. A method as claimed in claim 1 comprising calculating said diagnostically relevant image from said graphics overview representation, with no new image reconstruction.

27. A method as claimed in claim 1 comprising, in said computer, conducting retrospective filtering of data for calculating said diagnostically relevant image.

28. A method as claimed in claim 1 comprising storing said diagnostically relevant image in said computer.

29. A method as claimed in claim 1 wherein a stack of transfers tomograms can be theoretically calculated from said raw data set of said scanned volume, and wherein said computer stores said diagnostically relevant image without storage of said stack of transfers tomograms.

30. A method as claimed in claim 1 wherein said computer transmits said diagnostically relevant image to a further computer, separate from said computer.

31. A method as claimed in claim 30 wherein a stack of transfers tomograms can be theoretically calculated from said raw data set of said scanned volume, and wherein said computer transmits said diagnostically relevant image without storage of said stack of transfers tomograms.

32. A method as claimed in claim 1 comprising executing all steps of said method within a common computer program.

33. A method as claimed in claim 32 comprising making all manual entries into said common computer program via a single user interface.

34. An x-ray computed tomography apparatus comprising:
a scanner adopted to interact with an examination subject to it detect penetrating radiation emitted into, or originating within, the examination subject from multiple directions relative to a system axis;
a computer with a display connected thereto;
an input unit connected to said computer allowing manual entry of a selected scan volume of said examination subject into a computer;
said computer operating said scanner to obtain a raw data set of said scan volume with data in said raw data set being respectively allocated to different ones of said directions and at a time no later than immediately following termination of obtaining said raw data set, electronically calculating a graphic overview representation of that said examination subject and displaying said graphic overview at said display for allowing planning of a subsequent calculation of a diagnostic image, said graphic overview representation containing three-dimensional information about said scan volume;
said input unit allowing a manual selection, based on the displayed overview representation, of a diagnostically relevant region in said graphic overview representation; and
said computer, calculating, using an imaging calculation algorithm, a diagnostically relevant image in said selected diagnostically relevant region of said graphic overview representation.
